(19) United States
(12) Patent Application Publication
(10) Pub. No.: US 2006/0004486 A1
(43) Pub. Date: Jan. 5, 2006

(54) Monitoring robot

(75) Inventors: Taizou Yoshikawa, Wako-shi (JP); Masakazu Kawai, Wako-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: HONDA MOTOR CO., LTD.

(21) Appl. No.: 11/167,208

(22) Filed: Jun. 28, 2005

(30) Foreign Application Priority Data
Jun. 30, 2004 (JP) 2004-193757

(51) Int. Cl. G06F 19/00

(52) U.S. Cl. 700/245

(57) ABSTRACT

A monitoring robot capable of boarding a mobile unit such as a vehicle together with a driver to perform monitoring surrounding of the mobile unit, is provided. The robot has a microphone, a voice recognition unit voice-recognition processing a sound signal of the microphone, CCD cameras, an image recognition unit image-recognition processing image signals outputted by the CCD cameras, a driver's instruction recognition unit recognizing driver's instructions based on the processing results of the voice recognition and image recognition units. In the robot, the imaging direction of the CCD cameras is designated in response to the driver's instructions, and a monitoring result is assessed based on the image-recognition processing result. Then, one among a set of predetermined notice actions including a voice notice, is selected based on the recognized instructions and monitoring result, such that the driver is notified of the monitoring result in accordance with the selected notice action.

### BACKGROUND OF THE INVENTION

1. Field of the Invention

This invention relates to a monitoring robot, particularly to a mobile robot that boards a vehicle or other mobile unit to monitor one or more blind spots, such as, to the rear of the vehicle in accordance with driver instructions.

1. Description of the Related Art

Known monitoring robots include, for example, the one taught by Japanese Laid-Open Patent Application No. 2002-239959. This prior art reference relates to a pet-like robot that is placed, for example, in the front passenger's seat of a vehicle and is configured to help to relieve the driver's feeling of solitude by reacting in various ways according to vehicle driving conditions and also to function as an operating member for operating a blind spot monitoring camera. More specifically, the configuration is such that when the driver turns the head of the pet-like robot to the left or right, the imaging direction of a camera installed outside the vehicle for monitoring blind spots is correspondingly varied.

However, this prior art robot is troublesome to use because in order to change the direction of the external camera the driver is required to turn the robot's head and is also required to ascertain the direction of the blind spot to enable turning of the external camera in the right direction.

### SUMMARY OF THE INVENTION

An object of this invention is therefore to overcome these drawbacks by providing a monitoring robot that is capable of boarding a mobile unit together with the driver to perform monitoring in accordance with instructions of the driver recognized by the robot itself.

In order to achieve the object, this invention provides a monitoring robot capable of boarding a mobile unit together with a driver to perform monitoring surrounding of the mobile unit, comprising: a microphone picking up surrounding sounds including a voice of the driver; a voice recognition unit inputting and voice-recognition processing a sound signal outputted by the microphone; a CCD camera imaging the surroundings of the mobile unit; an image recognition unit inputting and image-recognition processing image signals generated and outputted by the CCD camera; a driver's instruction recognition unit recognizing instructions of the driver based on at least one of processing results of the voice recognition unit and the image recognition unit; an imaging direction designation unit designating an imaging direction of the CCD camera in response to the recognized instructions of the driver; a monitoring result assessment unit assessing a monitoring result based on the processing result of the image recognition unit; a notice action selection unit selecting one among a set of predetermined notice actions based on at least one of the recognized instructions and a result of the monitoring result assessment unit; and a notice unit notifying the driver of the monitoring result in accordance with the selected notice action.

### BRIEF DESCRIPTION OF THE DRAWINGS

The above and other objects and advantages of the invention will be more apparent from the following description and drawings in which:

FIG. 1 is a front view of a monitoring robot according to an embodiment of the invention;

FIG. 2 is a side view of the monitoring robot shown in FIG. 1;

FIG. 3 is an explanatory view showing a skeletonized view of the monitoring robot shown in FIG. 1;

FIG. 4 is an explanatory view showing the monitoring robot of FIG. 1 aboard a vehicle (mobile unit);

FIG. 5 is a sectional view showing the internal structure of the head of the monitoring robot of FIG. 1;

FIG. 6 is a block diagram showing the configuration of an electronic control unit (ECU) shown in FIG. 3;

FIG. 7 is a block diagram functionally illustrating the operation of a microcomputer of the electronic control unit (ECU) shown in FIG. 6;

FIG. 8 is a block diagram showing the configuration of a navigation system installed in the vehicle shown in FIG. 4;

FIG. 9 is an explanatory view of the vicinity of the driver's seat shown in FIG. 4, showing where the display of the navigation system of FIG. 8 is installed;

FIG. 10 is a flowchart showing the sequence of operations of the monitoring robot of FIG. 1; and

FIG. 11 is a top view of the vehicle of FIG. 4 for explaining the operations of FIG. 10, showing the robot of FIG. 1 seated at the side of the driver.

### DETAILED DESCRIPTION OF THE PREFERRED EMBODIMENT

A preferred embodiment of the monitoring robot according to the invention will now be explained with reference to the attached drawings.

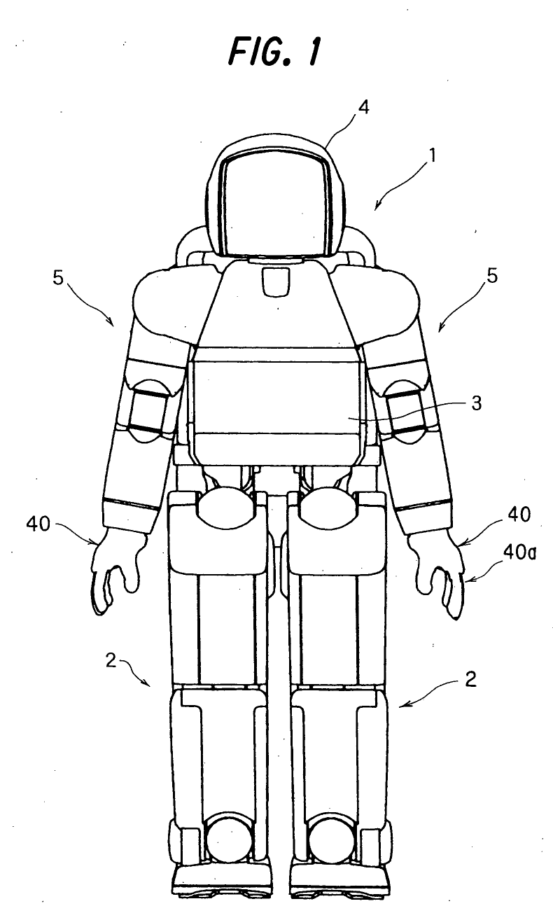

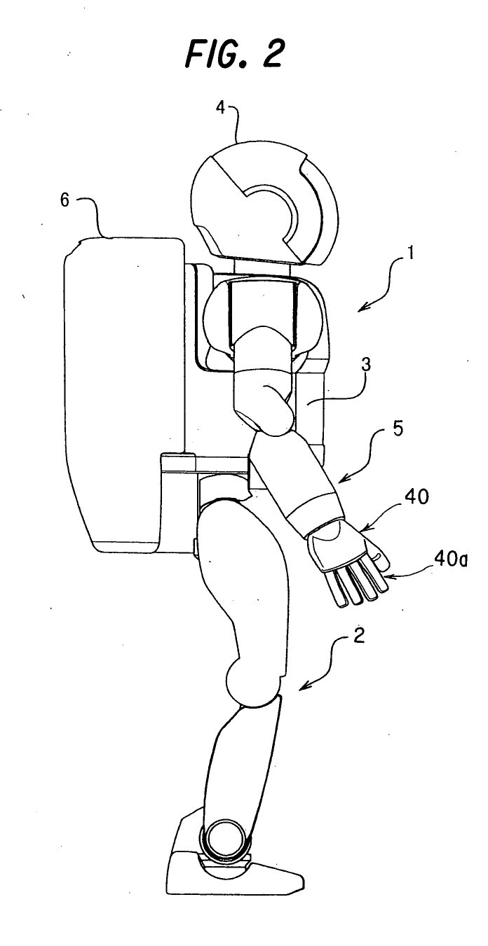

FIG. 1 is a front view of a monitoring robot according to an embodiment of the invention and FIG. 2 is a side view thereof. A humanoid legged mobile robot (mobile robot modeled after the form of the human body) provided with two legs and two arms and capable of bipedal locomotion, is taken as an example of monitoring robots.

As shown in FIG. 1, the monitoring robot (now assigned with reference numeral 1 and hereinafter referred to as “robot”) is equipped with a plurality, specifically a pair of leg linkages 2 and a body (upper body) 3 above the leg linkages 2. A head 4 is formed on the upper end of the body 3 and two arm linkages 5 are connected to opposite sides of the body 3. As shown in FIG. 2, a housing unit 6 is mounted on the back of the body 3 for accommodating an electronic control unit (explained later), a battery and the like.

The robot 1 shown in FIGS. 1 and 2 is equipped with covers for protecting its internal structures. A keyless entry system 7 (not shown in FIG. 2) is provided inside the robot 1.

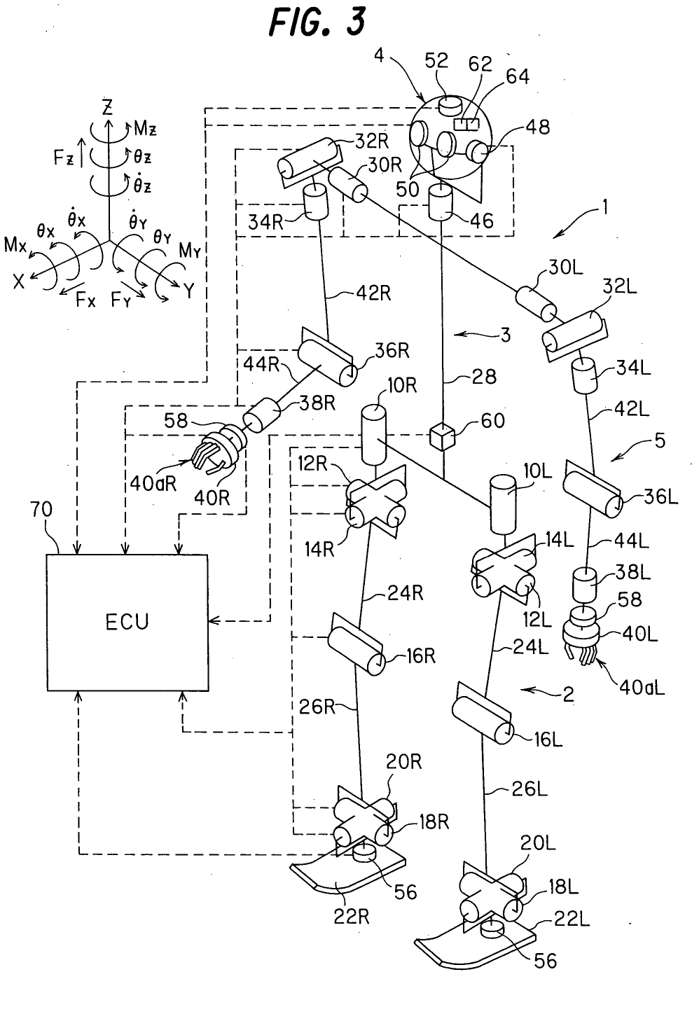

FIG. 3 is an explanatory diagram showing a skeletonized view of the robot 1. The internal structures of the robot 1 will be explained with reference to this drawing, with primary focus on the joints. As illustrated, the leg linkages 2 and arm linkages 5 on either the left or right of the robot 1 are equipped with six joints driven by 11 electric motors.

Specifically, the robot 1 is equipped at its hips (crotch) with electric motors 10R, 10L (R and L indicating the right and left sides; hereinafter the indications R and L will be omitted as is apparent for its symmetric structure) constituting joints for swinging or swiveling the leg linkages 2 around a vertical axis (the Z axis or vertical axis), electric motors 12 constituting joints for driving (swinging) the leg linkages 2 in the pitch (advance) direction (around the Y axis), and electric motors 14 constituting joints for driving the leg linkages 2 in the roll (lateral) direction (around the X axis), is equipped at its knees with electric motors 16 constituting knee joints for driving the lower portions of the leg linkages 2 in the pitch direction (around the Y axis), and is equipped at its ankles with electric motors 18 constituting foot (ankle) joints for driving the distal ends of the leg linkages 2 in the pitch direction (around the Y axis) and electric motors 20 constituting foot (ankle) joints for driving them in the roll direction (around the X axis).

As set out in the foregoing, the joints are indicated in FIG. 3 by the axes of rotation of the electric motors driving the joints (or the axes of rotation of transmitting elements (pulleys, etc.) connected to the electric motors for transmitting the power thereof). Feet 22 are attached to the distal ends of the leg linkages 2.

In this manner, the electric motors 10, 12 and 14 are disposed at the crotch or hip joints of the leg linkages 2 with their axes of rotation oriented orthogonally, and the electric motors 18 and 20 are disposed at the foot joints (ankle joints) with their axes of rotation oriented orthogonally. The crotch joints and knee joints are connected by thigh links 24 and the knee joints and foot joints are connected by shank links 26.

The leg linkages 2 are connected through the crotch joints to the body 3, which is represented in FIG. 3 simply by a body link 28. The arm linkages 5 are connected to the body 3, as set out above.

The arm linkages 5 are configured similarly to the leg linkages 2. Specifically, the robot 1 is equipped at its shoulders with electric motors 30 constituting joints for driving the arm linkages 5 in the pitch direction and electric motors 32 constituting joints for driving them in the roll direction, is equipped with electric motors 34 constituting joints for swiveling the free ends of the arm linkages 5, is equipped at its elbows with electric motors 36 constituting joints for swiveling parts distal thereof, and is equipped at the distal ends of the arm linkages 5 with electric motors 38 constituting wrist joints for swiveling the distal ends. Hands (end effectors) 40 are attached to the distal ends of the wrists.

In other words, the electric motors 30, 32 and 34 are disposed at the shoulder joints of the arm linkages 5 with their axes of rotation oriented orthogonally. The shoulder joints and elbow joints are connected by upper arm links 42 and the elbow joints and wrist joints are connected by forearm links 44.

Although not shown in the figure, the hands 40 are equipped with a driving mechanism comprising five fingers 40a. The fingers 40a are configured to be able to carry out a task, such as grasping an object.

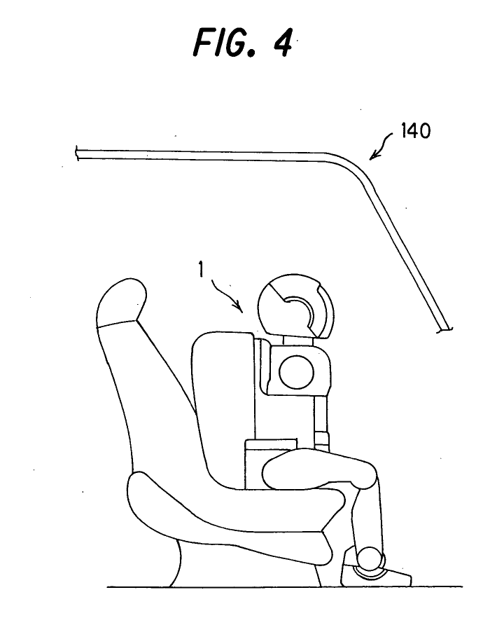

The head 4 is connected to the body 3 through an electric motor (comprising a neck joint) 46 around a vertical axis and a head nod mechanism 48 for rotating the head 4 around an axis perpendicular thereto. As shown in FIG. 3, the interior of the head 4 has mounted therein two CCD cameras (external sensor) 50 that can produce stereoscopic images, and a voice input/output device 52. The voice input/output device 52 comprises a microphone (external sensor) 52a and a speaker 52b, as shown in FIG. 4 later.

Owing to the foregoing configuration, the leg linkages 2 are each provided with 6 joints constituted of a total of 12 degrees of freedom for the left and right legs, so that during locomotion the legs as a whole can be imparted with desired movements by driving (displacing) the six joints to appropriate angles to enable desired walking in three-dimensional space. Further, the arm linkages 5 are each provided with 5 joints constituted of a total of 10 degrees of freedom for the left and right arms, so that desired tasks can be carried out by driving (displacing) these 5 joints to appropriate angles. In addition, the head 4 is provided with a joint and the head nod mechanism constituted of two 2 degrees of freedom, so that the head 4 can be faced in a desired direction by driving these to appropriate angles.

FIG. 4 is a side view showing the robot 1 seated in a vehicle (mobile unit) V. The robot 1 is configured for seating in the vehicle V or other mobile unit by driving the aforesaid joints. In this embodiment, the robot 1 sits in the front passenger's seat to guard the vehicle V to monitor blind spots.

Each of the electric motors 10 and other motors is provided with a rotary encoder that generates a signal corresponding to at least one among the angle, angular velocity and angular acceleration of the associated joint produced by the rotation of the rotary shaft of the electric motor.

A conventional six-axis force sensor (internal sensor; hereinafter called “force sensor”) 56 attached to each foot member 22 generates signals representing, of the external forces acting on the robot, the floor reaction force components Fx, Fy and Fz of three directions and the moment components Mx, My and Mz of three directions acting on the robot from the surface of contact.

A similar force sensor (six-axis force sensor) 58 attached between each wrist joint and hand 40 generates signals representing external forces other than floor reaction forces acting on the robot 1, namely, the three external force (reaction force) components Fx, Fy and Fz and the three moment components Mx, My and Mz acting on the hand 40 from a touched object.

An inclination sensor (internal sensor) 60 installed on the body 3 generates a signal representing at least one of inclination (tilt angle) of the body 3 relative to vertical and the angular velocity thereof, i.e., representing at least one quantity of state such as the inclination (posture) of the body 3 of the robot 1.

A GPS receiver 62 for receiving signals from the Global Positioning System (GPS) and gyro (gyrocompass) 64 are installed inside the head 4 in addition to the aforesaid CCD cameras 50 and voice input-output unit 52.

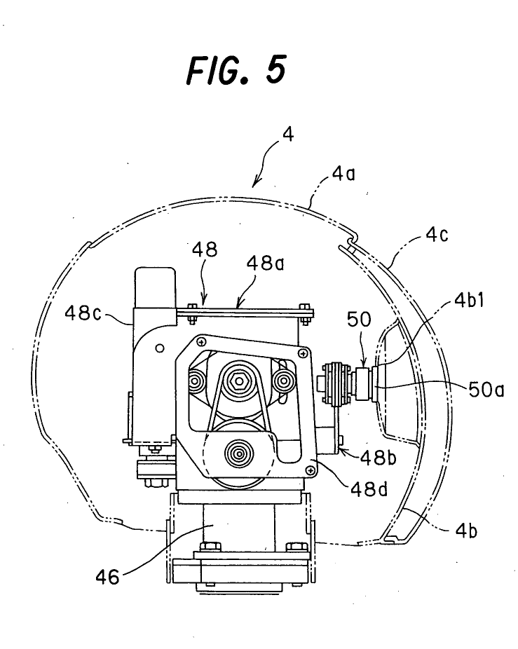

The attachment of the nod mechanism 48 and the CCD cameras 50 of the head 4 will now be explained with reference to FIG. 5. The nod mechanism 48 comprises a first mount 48a rotatable about a vertical axis and a second mount 48b rotatable about a roll axis.

The nod mechanism 48 is constituted by coupling the second mount 48b with the first mount 48a, in a state with the first mount 48a coupled with the electric motor (joint) 46, and the CCD cameras 50 are attached to the second mount 48b. Further, a helmet 4a that is a constituent of the head 4 covering the first and second mounts 48a, 48b, including a rotary actuator 48c (and another not shown), is joined in the direction perpendicular to the drawing sheet to a stay 48d substantially unitary with the second mount 48b, thereby completing the head 4. The voice input-output unit 52 is also installed in the head 4 but is not shown in FIG. 5.

A visor (protective cover) 4b is attached to the front end of the helmet 4a of the head 4 and a curved shield 4c made of transparent acrylic resin material is similarly attached to the helmet 4a outward of the visor 4b. The CCD cameras 50 are accommodated inward of the visor 4b. The visor 4b is formed at regions opposite openings formed for passage of light to the CCD cameras 50, i.e., at a position where lens windows 50a of the CCD cameras 50 look outward, with two holes 4b1 of approximately the same shape as the lens windows 50a. Although not shown in the drawing, the two holes 4b1 for the CCD cameras are formed at locations corresponding to eye sockets of a human being.

The structure explained in the foregoing makes the helmet 4a of the head 4 substantially unitary with the second mount 48b, so that the direction from which the CCD cameras 50 fastened to the second mount 48b receive light always follows the movement of the helmet 4a. Moreover, since the shield 4c is attached to the helmet 4a, light passing in through the shield 4c always passes through the same region regardless of the direction in which the CCD cameras 50 are pointed. As a result, the refractive index of the light passing through the shield 4c never changes even if the curvature of the shield 4c is not absolutely uniform. The images taken by the CCD cameras 50 are therefore free of distortion so that clear images can be obtained at all times.

The explanation of FIG. 3 will be continued. The outputs of the force sensors 56 and the like are sent to an electronic control unit (ECU) 70 comprising a microcomputer. The ECU 70 is accommodated in the housing unit 6. For convenience of illustration, only the inputs and outputs on the right side of the robot 1 are indicated in the drawing.

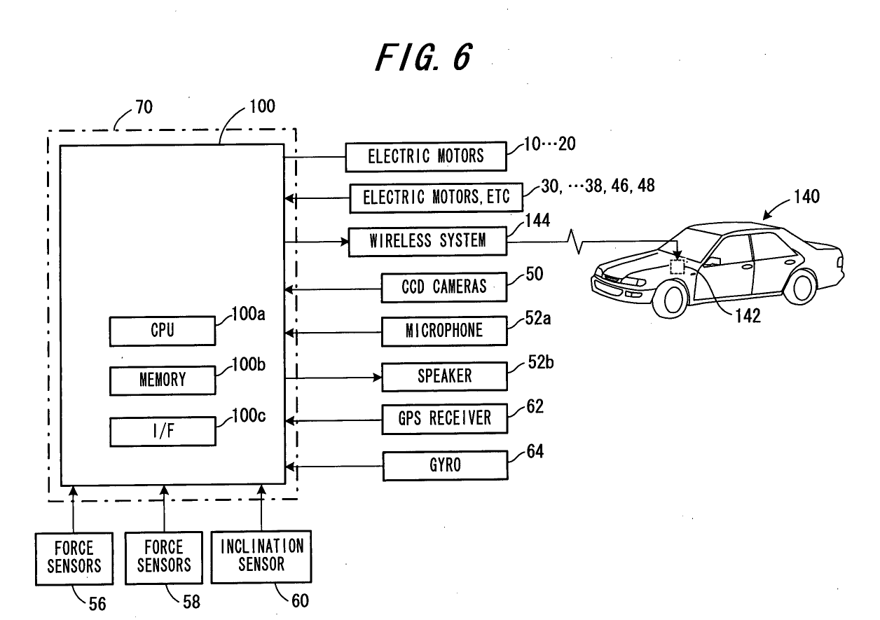

FIG. 6 is a block diagram showing the configuration of the ECU 70.

As illustrated, the ECU 70 is equipped with a microcomputer 100 comprising a CPU 100a, memory unit 100b and input-output interface 100c. The ECU 70 calculates joint angular displacement commands that it uses to control the electric motors 10 and other motors constituting the joints so as to enable the robot 1 to keep a stable posture while moving. As explained below, it also performs various processing operations required for blind spot monitoring security tasks. These will be explained later.

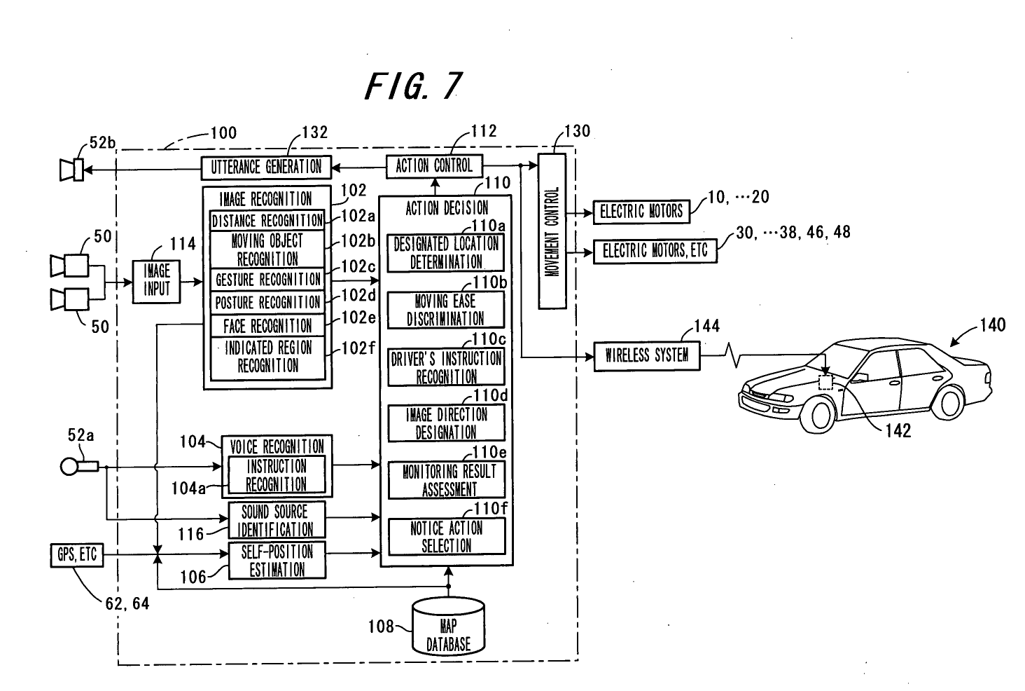

FIG. 7 is a block diagram showing the processing operations of the CPU 100a in the microcomputer 100 of the ECU 70. It should be noted that many of the sensors are not shown in FIG. 7.

As can be seen from FIG. 7, the CPU 100a is equipped with, inter alia, an image recognition unit 102, voice recognition unit 104, self-position estimation unit 106, map database 108, action decision unit 110 for deciding actions of the robot 1 based on the outputs of the foregoing units, and action control unit 112 for controlling actions of the robot 1 based on the actions decided by the action decision unit 110. For convenience of illustration, the term “unit” is omitted in the drawing.

These units will be explained individually.

The image recognition unit 102 comprises a distance recognition unit 102a, moving object recognition unit 102b, gesture recognition unit 102c, posture recognition unit 102d, face region recognition unit 102e, indicated region recognition unit 102f. Stereoscopic images of the surroundings taken and produced by the two CCD cameras 50 are inputted to the distance recognition unit 102a through an image input unit 114.

The distance recognition unit 102a calculates data representing distances to imaged objects from the parallax of the received images and creates distance images. The moving body recognition unit 102b receives the distance images and calculates differences between images of multiple frames to recognize (detect) moving objects such as people, vehicles and the like.

The gesture recognition unit 102c utilizes techniques taught in Japanese Laid-Open Patent Application No. 2003-077673 (proposed by the assignee) to recognize human hand movements and compares them with characteristic hand movements stored in memory beforehand to recognize gestured instructions accompanying human utterances. In this embodiment, since the robot 1 is configured to implement blind spot monitoring, it recognizes that the driver gives an instruction to monitor blind spots to the rear of the vehicle, if the driver shows the gesture to point his thumb to the rear.

The posture recognition unit 102d uses techniques taught in Japanese Laid-Open Patent Application No. 2003-039365 (proposed by the assignee) to recognize human posture. The face region recognition unit 102e uses techniques taught in Japanese Laid-Open Patent Application No. 2002-216129 (proposed by the assignee) to recognize human face regions. The indicated region recognition unit 102f uses techniques taught in Japanese Laid-Open Patent Application No. 2003-094288 (proposed by the assignee) to recognize regions or directions indicated by human hands and the like.

The voice recognition unit 104 is equipped with an instruction region recognition unit 104a. The instruction region recognition unit 104a receives the human voices inputted through the microphone 52a of the voice input-output unit and uses vocabulary stored in the memory unit 100b beforehand to recognize human instructions or instruction regions (regions instructed by a person). In this embodiment, the vocabulary stored in the memory unit 100b includes phrases used in monitoring such as “watch behind”. The voice inputted from the microphone 52a is sent to a sound source identification unit 116 that identifies or determines the position of the sound source and discriminates between voice made by a human being and other abnormal sounds produced by, for instance, someone trying to force a door open.

The self-position estimation unit 106 receives GPS signals or the like through a GPS receiver 62 and uses them to estimate (detect) the current position of the robot 1 and the direction in which it is facing.

The map database 108 resides in the memory unit 100b and stores map information compiled in advance by recording the locations of obstacles within the surrounding vicinity.

The action decision unit 110 is equipped with a designated location determination unit 110a, moving ease discrimination unit 110b, driver's instruction recognition unit 110c, image direction designation unit 110d, monitoring result assessment unit 110e and notice action selection unit 110f.

Based on the region the image recognition unit 102 recognized as that designated by a person and the designated region zoomed in by the voice recognition unit 104, the designated location determination unit 110a determines or decides, as a desired movement destination value, the location designated by the person.

The moving ease discrimination unit 110b recognizes the locations of obstacles present in the map information read from the map database 108 for the region around the current location of the robot 1, defines the areas near the obstacles as hazardous zones, defines zones up to a certain distance away from the defined hazardous zones as potentially hazardous zones and judges the moving ease in these zones as “difficult,” “requiring caution” or similar.

The action decision unit 110 uses the recognition results of the image recognition unit 102 and voice recognition unit 104 to discriminate whether it is necessary to move to the designated location determined by the designated location determination unit 110a. Further, when the moving ease discrimination unit 110b makes a “difficult” determination or the like based on the determined moving ease, the action decision unit 110 decides, for example, to lower the walking speed and decides the next action of the robot 1 in response to information received from the image recognition unit 102, voice recognition unit 104 and the like, at which time it may, for example, respond to sound source position information outputted by the sound source identification unit 116 by deciding an action for, for example, reorienting the robot 1 to face toward the sound source.

Explanation will be made later regarding the driver's instruction recognition unit 110c and on.

The action decisions of the action decision unit 110 are sent to the action control unit 112. In response to the decided action, the action control unit 112 outputs instructions of action necessary for monitoring to a movement control unit 130 or an utterance generation unit 132.

The movement control unit 130 is responsive to instructions from the action control unit 112 for outputting drive signals to the electric motors 10 and other motors of the legs 2, head 4 and arms 5, thereby causing the head 4 to move (rotate).

In accordance with instructions from the action control unit 112, the utterance generation unit 132 uses character string data for utterances to be made stored in the memory unit 100b to synthesize voice signals for the utterances and uses them to drive a speaker 52b of the voice input-output unit 52. The character string data for utterances to be made includes data for monitoring such as “OK? “Stop, child behind!”

The driver instruction recognition unit 110c and the like will now be explained.

As explained earlier, this invention is directed to providing a monitoring robot that is capable of boarding a mobile unit such as the vehicle 140 together with the driver to perform monitoring in accordance with instructions of the driver recognized by the robot itself.

In line with this object, the monitoring robot 1 in accordance with this embodiment comprises a microphone 52a for picking up surrounding sounds including the voice of the driver, a voice recognition unit 104 for inputting or receiving and voice-recognition processing a sound signal outputted by the microphone 52a, CCD cameras 50 for imaging or photographing the surroundings, an image recognition unit 102 for inputting or receiving and image-recognition processing image signals generated and outputted by the CCD cameras 50, the recognition unit 110c for recognizing instructions of the driver based on at least one result between the processing results of the voice recognition unit 104 and the image recognition unit 102, an imaging direction designation unit 110d for designating the imaging direction of the CCD cameras 50 in response to the recognized instructions, a monitoring result assessment unit 110e for assessing the monitoring result based on the imaging processing result, and a notice action selection unit 110f for selecting one among a set of predetermined notices based on at least one between the recognized instructions and the assessed monitoring result. Further, it is configured to operate the action control unit 112 as a notice unit for notifying the driver of the monitoring result in accordance with the selected notice action.

On the other hand, the vehicle (mobile unit) 140 in which the robot 1 rides together with the driver is provided with a navigation system 142.

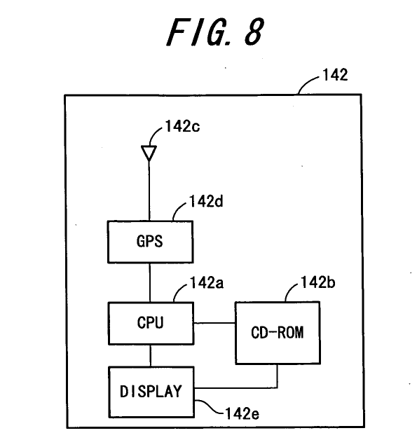

FIG. 8 is a block diagram showing the configuration of the navigation system 142. As illustrated, the navigation system 142 is equipped with a CPU 142a, a CD-ROM 142b storing a wide-area roadmap covering the region in which the vehicle 140 is driven, a GPS receiver 142d, similar to the GPS receiver 62 built into the robot 1, that receives GPS signals through an antenna 142, and a display 142e. The ECU 70 of the robot 1 can transmit signals to the navigation system 142 installed in the vehicle 140 through the wireless unit 144.

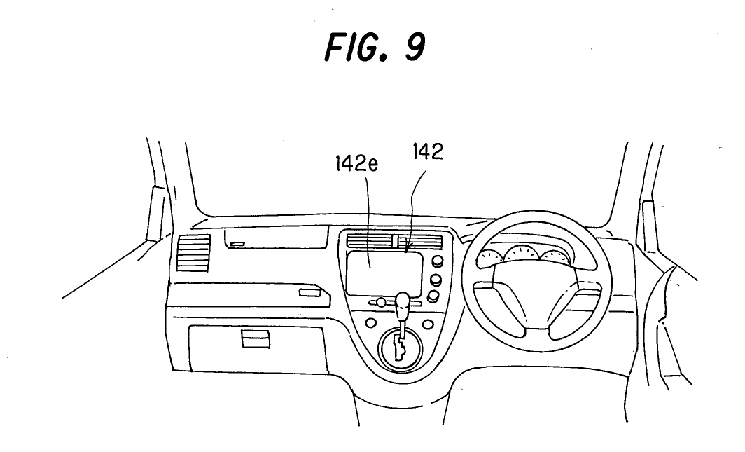

As shown in FIG. 9, the display 142e of the navigation system 142 is situated near the driver's seat for easy viewing by the driver.

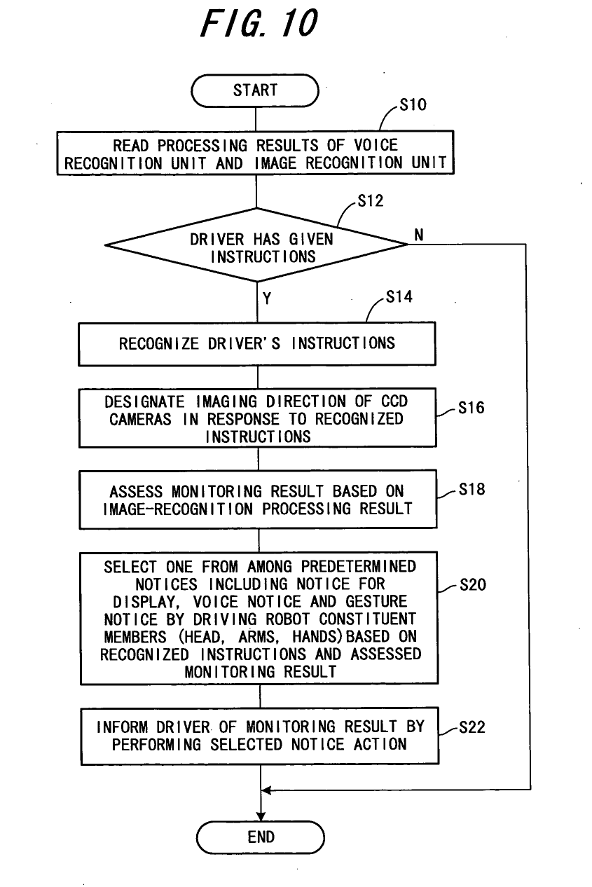

The operation of the robot 1 shown in FIG. 1 will now be explained with reference to the flowchart of FIG. 10. Exactly speaking, these are operations executed by the CPU 100a of the microcomputer 100 of the ECU 70.

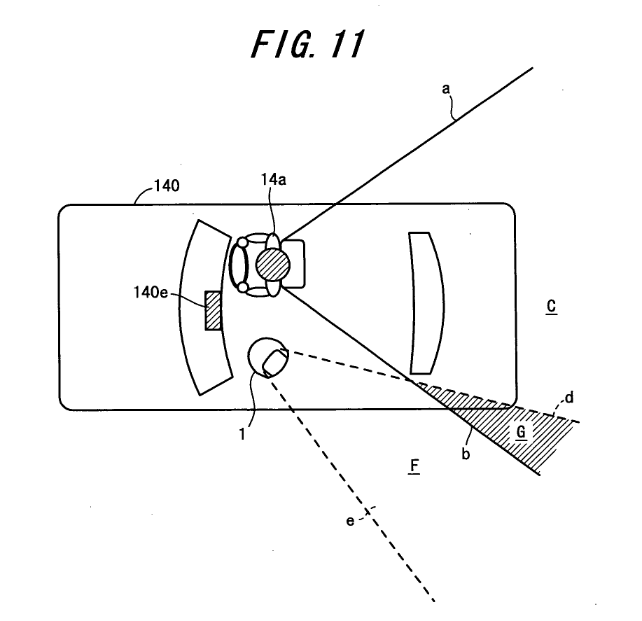

The routine shown in FIG. 10 assumes that the robot 1 is seated in the vehicle 140 next to a driver 140a as shown in FIG. 11.

In S10, the processing results of the voice recognition unit 104 and image recognition unit 102 are read. Next, in S12, it is checked based on at least one result between the processing results of the voice recognition unit 104 and the image recognition unit 102 whether the driver has given instructions. When the result is Yes, the driver's instructions are recognized in S14.

As can be seen in FIG. 11, an angular region C bounded by lines a, b is a blind zone for the driver 140a without mirrors. An angular region G is a blind zone for the driver 140a even if mirrors are used. On the other hand, the robot 1 seated in the front passenger's seat can secure an angular region F bounded by lines d, e as its field of vision by directing its head 4 to face the rear left. This is the zone that can be imaged and monitored by the CCD cameras 50 and, therefore, an angular range G can also be monitored

This embodiment assumes that the driver will give instructions by a voice command such as “Watch behind” and/or by a gesture command such as by pointing a finger to the rear. In S12, whether or not instructions have been given is discriminated from either or both of the processing results of the voice recognition unit 104 and the image recognition unit 102. When it is found that instructions have been given, the program goes to S14, in which the meaning of the instructions is recognized. When the result in S12 is No, the remaining steps are skipped.

Next, in S16, the imaging direction of the CCD cameras 50 is designated in response to the recognized instructions. Owing to the fact that the CCD cameras 50 are mounted on the head 4, the designation is made in the form of instructions to control the posture of the robot 1 for directing the head 4 to face in the direction concerned.

Next, S18, the monitoring result is assessed based on the image-recognition processing result of the image recognition unit 102. Specifically, assessment is made from processing performed by the distance recognition unit 102a, moving object recognition unit 102b and the like of the image recognition unit 102 as to whether an obstacle is present behind the vehicle 140 or whether a child, for instance, is present nearby.

Next, in S20, based on one or both of the recognized instructions and the assessed monitoring result, one notice is selected from among a set of predetermined notices (notice actions) including a notice for displaying on the display 142e, a voice notice to be made through the speaker 52b and a gesture notice to be made by driving constituent members of the robot (e.g., the head 4, arms 5, hands 40, fingers 40a and the like). The program then goes to S22, in which the driver 140a is informed of the monitoring result by performing the selected notice action.

In actual practice, when the driver gives a voice command such as “Watch behind” and/or a gesture command such as by pointing a finger to the rear, this is done solely by displaying the captured image on the display 142e. In other words, the image signal is merely outputted through the wireless unit 144 to be displayed on the display 142e of the navigation system 142 for viewed by the driver.

However, when the driver gives instructions by saying something like “Anything behind?” or “OK behind?” that implies he or she wants to be informed of the monitoring result, the display of an image on the display 142e is supplemented with a voice announcement through the speaker 52b like “Nothing behind” or “OK behind.”

Further, when the monitoring result assessment is that an object is present to the rear of the vehicle 140, particularly when it is that urgent action is required because, for example, a child is present immediately behind the vehicle 140, the display of an image on the display 142e is supplemented with a voice alarm through the speaker 52b such as “Obstacle behind!” or “Stop, child behind!” and one arm 5 is raised and the fingers 40a of the hand 40 are extended to make a stop gesture like a human would make.

Moreover, when, for example, the driver's instructions take the form of a finger pointed to the rear followed by a finger OK sign or other gesture meaning nothing is amiss, then if this is confirmed from the monitoring result assessment, the display of an image on the display 142e is skipped and a notice is given only by raising one arm 5 and making a similar OK sign with the fingers 40a of the hand 40.

As set out concretely in the foregoing, a notice made in accordance with the selected notice action is performed by, in the action control unit 112, sending action instructions to the movement control unit 130 and/or the utterance generation unit 132 to drive the electric motor 30 and other motors and/or drive the speaker 52b, and/or transmit the captured image through the wireless unit 144 for displaying on the display 142e of the navigation system 142 installed in the vehicle 140.

This embodiment is thus configured to have a monitoring robot (1) capable of boarding a mobile unit (e.g. vehicle 140) together with a driver to perform monitoring surrounding of the mobile unit, comprising: a microphone (52a) picking up surrounding sounds including a voice of the driver; a voice recognition unit (104) inputting and voice-recognition processing a sound signal outputted by the microphone; a CCD camera (CCD cameras 50) imaging the surroundings of the mobile unit; an image recognition unit (102) inputting and image-recognition processing image signals generated and outputted by the CCD camera; a driver's instruction recognition unit (CPU 100a, driver's instruction recognition unit 110c, S10 to S14) recognizing instructions of the driver based on at least one of processing results of the voice recognition unit and the image recognition unit; an imaging direction designation unit (CPU 100a, image direction designation unit 110d, S16) designating an imaging direction of the CCD camera in response to the recognized instructions of the driver; a monitoring result assessment unit (CPU 100a, monitoring result assessment unit 110e, S18) assessing a monitoring result based on the processing result of the image recognition unit; a notice action selection unit (CPU 100a, notice action selection unit 110f, S20) selecting one among a set of predetermined notice actions (including a notice for display on the display 142e, a voice notice to be made through the speaker 52b and a gesture notice to be made by driving constituent members of the robot, e.g., the head 4, arms 5, hands 40, fingers 40a and the like) based on at least one of the recognized instructions and a result of the monitoring result assessment unit; and a notice unit (CPU 100a, action control unit 112) notifying the driver of the monitoring result in accordance with the selected notice action.

In the monitoring robot, the set of predetermined notice actions including a notice action for displaying on a display (142a of navigation system 142) installed in the mobile unit.

In the monitoring robot, the set of predetermined notice actions including a voice notice action to be made through a speaker (52b) installed at the robot.

In the monitoring robot, wherein the CCD camera is accommodated inward of a visor (4b) that is formed with a hole (4b1) at a position corresponding to a lens window (50a) of the CCD camera (cameras 50), and the hole (4b1) has a same diameter as the lens window (50a).

The monitoring robot (1) comprises a biped robot having a body (3) and a pair of legs (2) connected to the body.

It should be noted that, although the vehicle 140 has been taken as an example of a mobile unit in the foregoing, this invention is not limited to application to a vehicle but can be similarly applied to a boat, airplane or other mobile unit.

It should also be noted that, although a biped robot has been taken as an example of the invention robot in the foregoing, the robot is not limited to a biped robot and can instead be a robot with three or more legs and is not limited to a legged mobile robot but can instead be a wheeled or crawler-type robot.

Japanese Patent Application No. 2004-193757 filed on Jun. 30, 2004, is incorporated herein in its entirety.

While the invention has thus been shown and described with reference to specific embodiments, it should be noted that the invention is in no way limited to the details of the described arrangements; changes and modifications may be made without departing from the scope of the appended claims.

What is claimed is:

1. A monitoring robot capable of boarding a mobile unit together with a driver to perform monitoring surrounding of the mobile unit, comprising:
a microphone picking up surrounding sounds including a voice of the driver;
a voice recognition unit inputting and voice-recognition processing a sound signal outputted by the microphone;
a CCD camera imaging the surrounding of the mobile unit;
an image recognition unit inputting and image-recognition processing image signals generated and outputted by the CCD camera;
a driver's instruction recognition unit recognizing instructions of the driver based on at least one of processing results of the voice recognition unit and the image recognition unit;
an imaging direction designation unit designating an imaging direction of the CCD camera in response to the recognized instructions of the driver;
a monitoring result assessment unit assessing a monitoring result based on the processing result of the image recognition unit;
a notice action selection unit selecting one among a set of predetermined notice actions based on at least one of the recognized instructions and a result of the monitoring result assessment unit; and
a notice unit notifying the driver of the monitoring result in accordance with the selected notice action.

2. The monitoring robot according to claim 1, the set of predetermined notice actions including a notice action for displaying on a display installed in the mobile unit.

3. The monitoring robot according to claim 1, the set of predetermined notice actions including a voice notice action to be made through a speaker installed at the robot.

4. The monitoring robot according to claim 1, wherein the CCD camera is accommodated inward of a visor that is formed with a hole at a position corresponding to a lens window of the CCD camera.

5. The monitoring robot according to claim 4, wherein the hole has a same diameter as the lens window.

6. The monitoring robot according to claim 1, wherein the robot comprises a biped robot having a body and a pair of legs connected to the body.
